(19) United States
(12) Patent Application Publication
(10) Pub. No.: US 2005/0198415 A1
(43) Pub. Date: Sep. 8, 2005

(54) Couplable and operatable hard disk

(76) Inventor: Kan Chun Chiang, Keelung City (TW)

Correspondence Address: CHARLES E. BAXLEY, ESQ., 90 JOHN STREET, THIRD FLOOR, NEW YORK, NY, 10038, US

(21) Appl. No.: 10/796,519

(22) Filed: Mar. 8, 2004

(51) Int. Cl. G06F 13/10

(52) U.S. Cl. 710/62

(57) ABSTRACT

A hard disk includes an MPU, a memory unit coupled to the MPU for data storing and accessing purposes, a monitor control interface coupled to the MPU for controlling the MPU, a storing interface coupled to the MPU for data storing and accessing purposes, a transmission interface coupled to the MPU, for communicating with other facilities, and a power unit coupled to the MPU, for energizing the MPU. The MPU is operatable with the monitor control interface to communicate with other facilities without coupling the hard disk to further computer facilities.

### BACKGROUND OF THE INVENTION

1. Field of the Invention

The present invention relates to a hard disk, and more particularly to an operatable hard disk for easily connecting to the other computer facilities by wires or wirelessly.

2. Description of the Prior Art

Typical hard disks have been developed and widely used in various computer facilities, and may comprise a processor device, a disk drive device, one or more memories, and an interface for coupling to the computer facilities.

However, the typical hard disks themselves may not be operated unless coupled to the computer facilities; i.e., the typical hard disks may only be operated after the typical hard disks are coupled to the computer facilities and operated by the computer facilities.

For example, U.S. Pat. No. 6,188,571 to Roganti et al. and U.S. Pat. No. 6,301,105 to Glorioso et al. disclose two of the conventional hard disks each comprising one or more memories for coupling to various kinds of computer facilities. Similarly, the typical hard disks also may not be operated themselves and should be coupled to the computer facilities and operated by the computer facilities.

For allowing the computer facilities to be used or operated by the users easily, notebook computer facilities have been developed and may be carried with the users. However, the typical notebook computer facilities are expensive, and may comprise a volume and a weight much greater than the typical hard disks, such that the typical notebook computer facilities may not be easily carried with the users.

The present invention has arisen to mitigate and/or obviate the afore-described disadvantages of the conventional hard disks.

### SUMMARY OF THE INVENTION

The primary objective of the present invention is to provide an operatable hard disk for easily connecting to the other computer facilities by wires or wirelessly.

In accordance with one aspect of the invention, there is provided a hard disk comprising an MPU, a memory unit coupled to the MPU, for data storing and accessing purposes, a monitor control interface coupled to the MPU, for controlling the MPU, a storing interface coupled to the MPU, for data storing and accessing purposes, a transmission interface coupled to the MPU, for communicating with other facilities, and a power unit coupled to the MPU, for energizing the MPU. The MPU is operatable with the monitor control interface to communicate with other facilities without coupling the hard disk to further computer facilities.

The transmission interface includes a wireless interface and a cable interface for communicating with the other facilities. The cable interface is selected from USB interface or 1394 interface. The power unit includes at least one battery and a power circuit.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram of a hard disk in accordance with the present invention;

FIG. 2 is another block diagram of the hard disk, illustrating details of the hard disk;

FIG. 3 is a further block diagram illustrating the operation of the hard disk; and

FIG. 4 is a schematic view illustrating the coupling or connecting of the hard disk to various computer facilities.

### DETAILED DESCRIPTION OF THE PREFERRED EMBODIMENT

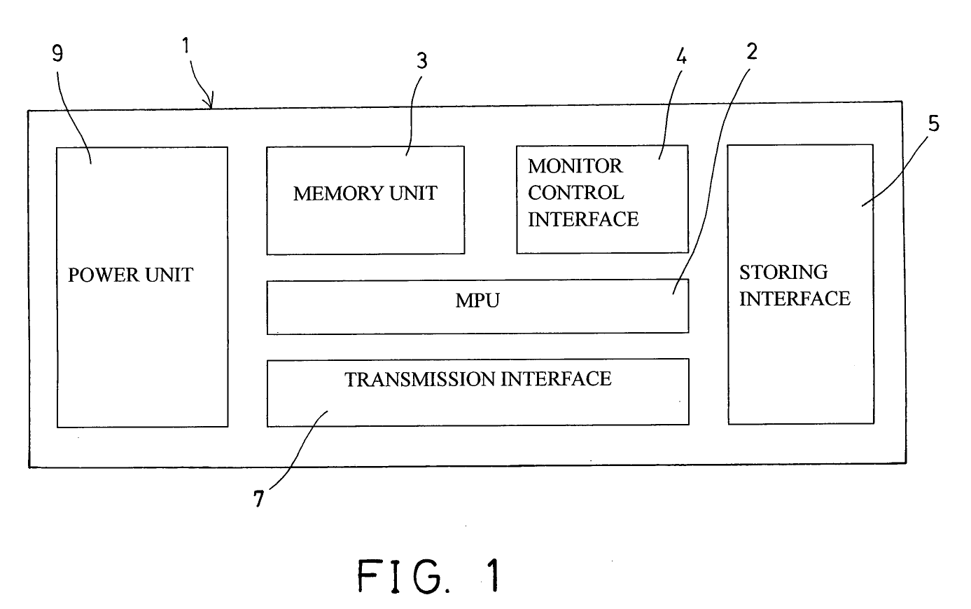

Referring to the drawings, and initially to FIG. 1, a hard disk 1 in accordance with the present invention comprises a micro processor unit (MPU) 2 for data processing purposes, a memory unit 3, a monitor control interface 4, a saving or storing interface 5, a transmission interface 7, and a power unit 9.

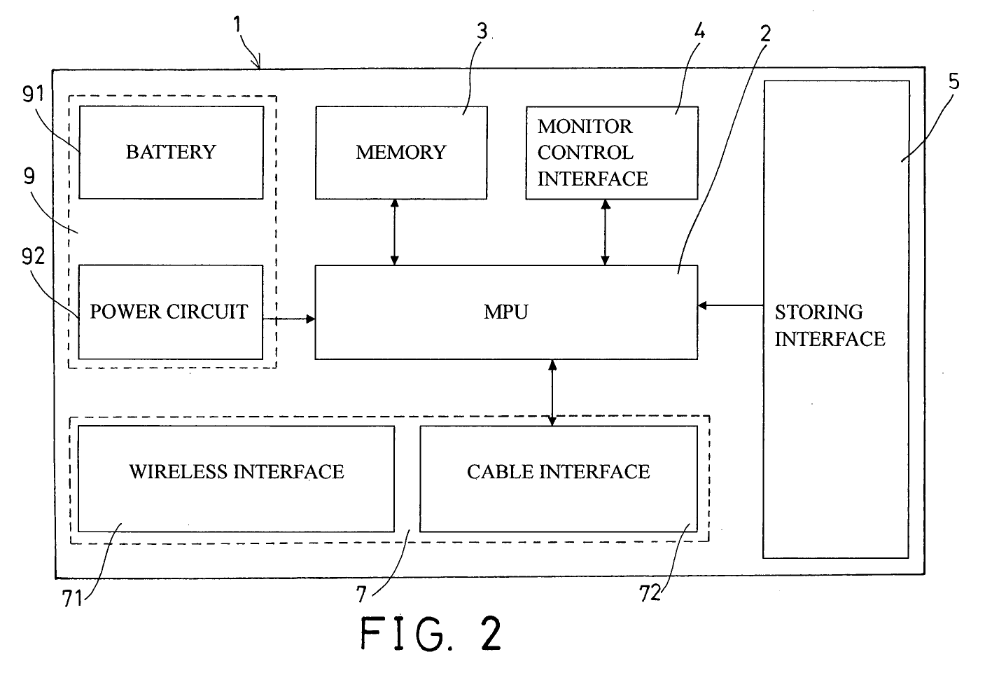

For example, as shown in FIG. 2, the memory unit 3 is coupled to the MPU 2 for storing various data or information and for allowing the stored data or information to be sent out of the hard disk 1, the monitor control interface 4 is coupled to the MPU 2 and includes control keys (not shown) for inputting control signals or information to the MPU 2, in order to control the MPU 2.

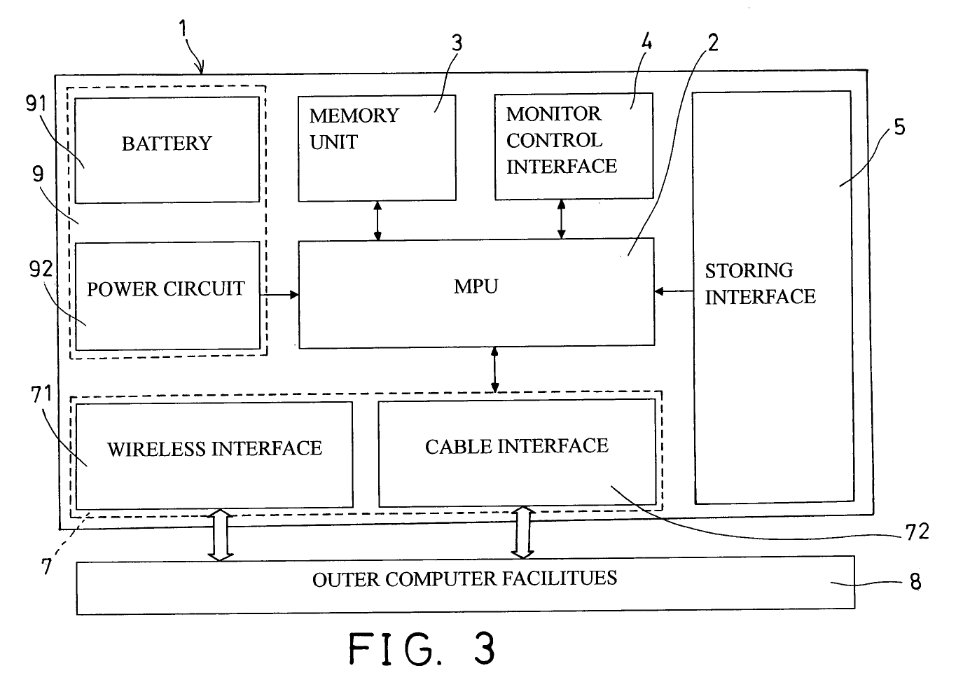

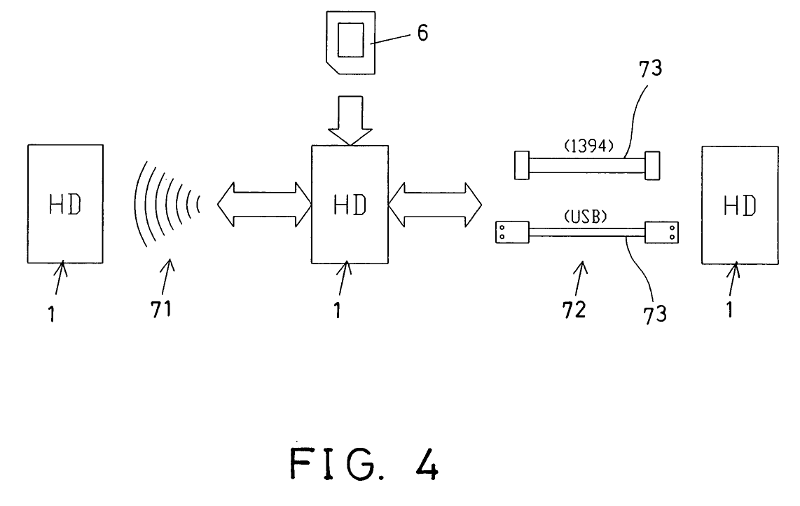

The saving or storing interface 5 is coupled to the MPU 2 and may be used to read or store the data or information of one or more data cards 6 (FIG. 4) which may be coupled or plugged to the hard disk 1. The transmission interface 7 is coupled to the MPU 2 and includes a wireless interface 71 and a cable interface 72 for coupling or connecting to or communicating with various computer facilities 8 wirelessly or via cable connections (FIG. 3).

For example, as shown in FIG. 4, the cable interface 72 may be selected from the typical universal serial bus (USB) interface, the typical 1394 interface, infrared interface, or the like, and may be used for coupling or connecting to the other computer facilities 8 via cables 73. The hard disk 1 itself may thus be operated to be coupled or connected to or communicated with the other computer facilities 8 without plugging or coupling to various computer facilities.

The power unit 9 includes one or more batteries 91 and a power circuit 92 coupled to the MPU 2, to supply electric power or energy to energize the MPU 2 or other devices.

In operation, the monitor control interface 4 may input control signals or information to the MPU 2, and thus to control the MPU 2. The data or information may be saved or stored into or accessed from the memory unit 3, and may be transmitted to or communicated with the other computer facilities 8 via cable connections 72, or wirelessly.

It is to be noted that the hard disk 1 in accordance with the present invention further includes a saving or storing interface 5 to read or store the data or information of one or more data cards 6 (FIG. 4), and thus to enlarge the storing capacity of the hard disk 1.

As shown in FIG. 4, two or more hard disks 1 may be coupled or connected together or communicating with each other wirelessly or via cable connections, for allowing the hard disks 1 to be operated without plugging or coupling to various computer facilities. For example, the data or information may be copied between the hard disks 1.

Accordingly, the operatable hard disk in accordance with the present invention may be used for easily connecting to the other computer facilities by wires or wirelessly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A hard disk comprising:
an MPU,
a memory unit coupled to said MPU, for data storing and accessing purposes,
a monitor control interface coupled to said MPU, for controlling said MPU,
a storing interface coupled to said MPU, for data storing and accessing purposes,
a transmission interface coupled to said MPU, for communicating with other facilities, and
a power unit coupled to said MPU, for energizing said MPU,
said MPU being operatable with said monitor control interface to communicate with other facilities without coupling said hard disk to further facilities.

2. The hard disk as claimed in claim 1, wherein said transmission interface includes a wireless interface and a cable interface for communicating with the other facilities.

3. The hard disk as claimed in claim 2, wherein said cable interface is selected from USB interface or 1394 interface.

4. The hard disk as claimed in claim 1, wherein said power unit includes at least one battery and a power circuit.
